(19) United States
(12) Patent Application Publication
(10) Pub. No.: US 2016/0335968 A1
(43) Pub. Date: Nov. 17, 2016

(54) LEVEL SHIFT CIRCUIT AND LEVEL SHIFT METHOD FOR GOA STRUCTURE LIQUID CRYSTAL PANEL

(71) Applicant: Shenzhen China Star Optoelectronics Technology Co. Ltd., Shenzhen City (CN)

(72) Inventors: Dekang ZENG, Shenzhen City (CN); Fengcheng XU, Shenzhen City (CN); Jingjing WU, Shenzhen City (CN)

(21) Appl. No.: 14/758,803

(22) PCT Filed: Apr. 1, 2015
(86) PCT No.: PCT/CN2015/075694

§ 371 Date: Jul. 1, 2016

(30) Foreign Application Priority Data
Mar. 3, 2015 (CN) 201510094520.8

(51) Int. Cl. G09G 3/36

(52) U.S. Cl. CPC G09G 3/3648; G09G 2330/021; G09G 2310/0289

(57) ABSTRACT

The present invention provides a level shift circuit and a level shift method for a GOA structure liquid crystal panel. The level shift chip (20) comprises a time delay calculation register module (201) and a start signal line (30) and an Inter-Integrated Circuit bus (40) are employed to communicatively couple the sequence controller (10) and the level shift chip (20).The sequence controller (10) performs initialization assignment (T1-Tn) to the time delay calculation register module (201), and sends a start signal (STV) to the level shift chip (20) via the start signal line (30); the level shift chip (20) is triggered to output the at least four sets of sequence signals (CKV1-CKVn) on a basis of the start signal (STV) according to the initialization assignment (T1-Tn) of the time delay calculation register module, and raises voltages of the start signal (STV) and the at least four sets of sequence signals (CKV1-CKVn) for driving the GOA structure liquid crystal panel (50) and realizing the generation of more sequence signals with lower cost.

### FIELD OF THE INVENTION

The present invention relates to a display technology field, and more particularly to a level shift circuit and a level shift method for a GOA structure liquid crystal panel.

### BACKGROUND OF THE INVENTION

The Active Matrix Liquid Crystal Display (AMLCD) is the most common display device at present. The Active Matrix Liquid Crystal Display comprises a plurality of pixels, and each pixel comprises a Thin Film Transistor (TFT). The gate of the TFT is coupled to the scan line extending along the horizontal direction. The drain of the TFT is coupled to the data line extending along the vertical direction. The source of the TFT is coupled to the corresponding pixel electrode. When a sufficient positive voltage is applied to some scan line in the horizontal direction, all the TFT coupled to the scan line will be activated to write the data signal loaded in the data line into the pixel electrodes and thus to show images.

One type of Active Matrix Liquid Crystal Display utilizes GOA (Gate Drive On Array) structure, which integrates the gate driver (Gate Drive IC) on the thin film transistor array substrate to achieve the scan line by line for driving the liquid crystal panel. Compared with the drive method that the Integrated Circuit (IC) is manufactured outside the liquid crystal panel by the CMOS process, the GOA structure can diminish the manufacture processes and reduce the cost for raising the integration of the liquid crystal panel, which is beneficial for realizing the ultra narrow frame and the slimming of the panel. However, the GOA structure causes the circuit drive board (PCBA) to be with an extra level shift IC, which raises the low voltage drive signal to be the high voltage drive signal to drive the TFTs in the liquid crystal panel for functioning.

Please refer to FIG. 1. The level shift circuit for the GOA structure liquid crystal panel according to prior art generally comprises: a sequence controller (TCON) 100 provided on the circuit drive board PCBA, and the sequence controller 100 is employed for generating and sending control signals, such as the start signal STV, the sequence signals CKVn, and n is a positive integer; a level shift chip 200 provided on the circuit drive board PCBA, and the level shift chip 200 is employed to raise the voltages of the start signal STV, the sequence signals CKVn transmitted from the sequence controller 100. The start signal STV and the sequence signals CKVn after raising the voltages by the level shift chip 200 drives the TFTs in the GOA structure liquid crystal panel 300.

For normally activating the TFTs in the GOA structure liquid crystal panel 300 line by line, four sets of sequence signals CKV1-CKV4 or more sequence signals are required in general for realizing the display effect of scan line by line. Each control signal needs the corresponding leads of the sequence controller 100 and the level shift chip 200 for the communicative coupling. As shown in FIG. 1, as there are four sets of sequence signals CKV1-CKV4 and one start signal STV, five pairs of corresponding leads are required for the communicative coupling of the sequence controller 100 and the level shift chip 200 to raise the voltage of each control signal.

As shown in FIG. 2, the sequence controller 100 generates the start signal STV, and sequentially generates the sequence signals CKV1, CKV2, CKV3, CKV4 respectively with interval T1, T2, T3, T4 on a basis of the rising edge of the start signal STV. The low voltage levels of the start signal STV and the sequence signals CKV1-CKV4 are 0 V, and the high voltage levels are 3.3 V. The continue periods of high voltage levels are T5 and the periodic times are T6. As shown in FIG. 3, after the level shift chip 200 raises the voltage levels, all the low voltage levels of the start signal STV, and the sequence signals CKV1-CKV4 are −6 V, and the high voltage levels are 30 V. The intervals, the continue periods, periodic times of high voltage levels of the sequence signals CKV1-CKV4 relative to the rising edge of the start signal STV remain to be unchanged.

Although the aforesaid level shift circuit for the GOA structure can raise the voltage of each control signal to drive the TFTs in the liquid crystal panel, the leads required between the sequence controller 100 and the level shift chip 200 gets more and more as the required sequence signals CKVn become more and more. Every extra lead results in that the package size of the sequence controller 100 and the level shift chip 200 gets larger, and the dimension of the package size directly changes the cost of the IC. Meanwhile, more wirings make the dimension of the PCBA become larger and cost increase in advance. Therefore, as more sequence signals CKVn are required, the cost of the IC and the PCBA can be significantly increased and is disadvantageous to the purpose of lowering the cost with the GOA structure.

### SUMMARY OF THE INVENTION

An objective of the present invention is to provide a level shift circuit for a GOA structure liquid crystal panel, capable of decreasing the lead count between the sequence controller and the level shift chip to reduce the package size of the sequence controller and the level shift chip and to decrease the total wiring amount between the sequence controller and the level shift chip for reducing the dimension of the circuit drive board and lowering the production cost.

Another objective of the present invention is to provide a level shift method for a GOA structure liquid crystal panel, capable of generating more sequence signals, and meanwhile, decreasing the lead count between the sequence controller and the level shift chip to reduce the package size of the sequence controller and the level shift chip and to decrease the total wiring amount between the sequence controller and the level shift chip for reducing the dimension of the circuit drive board and lowering the production cost.

For realizing the aforesaid objective, the present invention first provides a level shift circuit for a GOA structure liquid crystal panel, comprising a sequence controller and a level shift chip;

the level shift chip comprises a time delay calculation register module;

the sequence controller is communicatively coupled to the level shift chip via a start signal line and an Inter-Integrated Circuit bus;

the sequence controller performs initialization assignment to the time delay calculation register module inside the level shift chip via the Inter-Integrated Circuit bus, and sends a start signal to the level shift chip via the start signal line;

the level shift chip is triggered to output at least four sets of sequence signals on a basis of the start signal according to the initialization assignment of the time delay calculation register module and raises voltages of the start signal and the at least four sets of sequence signals; the start signal and each set of sequence signal after raising the voltages are respectively transmitted to the GOA structure liquid crystal panel via one signal line.

The Inter-Integrated Circuit bus comprises a serial data signal line employed for transmitting serial data signals and a serial sequence signal line employed for transmitting serial sequence signals.

The level shift chip is triggered to output the at least four sets of sequence signals on a basis of a rising edge of the start signal according to the initialization assignment of the time delay calculation register module.

A generation point of the each set of sequence signal and the rising edge of the start signal are spaced with a corresponding initialization assignment.

Continue periods and periodic times of high voltage levels of the at least four sets of sequence signals are determined according to the initialization assignment of the time delay calculation register module.

The present invention relates to a display technology field, and more particularly to a level shift circuit and a level shift method for a GOA structure liquid crystal panel.

the level shift chip comprises a time delay calculation register module;

the sequence controller is communicatively coupled to the level shift chip via a start signal line and an Inter-Integrated Circuit bus;

the sequence controller performs initialization assignment to the time delay calculation register module inside the level shift chip via the Inter-Integrated Circuit bus, and sends a start signal to the level shift chip via the start signal line;

the level shift chip is triggered to output at least four sets of sequence signals on a basis of the start signal according to the initialization assignment of the time delay calculation register module and raises voltages of the start signal and the at least four sets of sequence signals; the start signal and each set of sequence signal after raising the voltages are respectively transmitted to the GOA structure liquid crystal panel via one signal line;

wherein the Inter-Integrated Circuit bus comprises a serial data signal line employed for transmitting serial data signals and a serial sequence signal line employed for transmitting serial sequence signals;

wherein the level shift chip is triggered to output the at least four sets of sequence signals on a basis of a rising edge of the start signal according to the initialization assignment of the time delay calculation register module.

The present invention further provides a level shift method for a GOA structure liquid crystal panel, comprising steps of:

step 1, providing the GOA structure liquid crystal panel and a level shift circuit for the GOA structure liquid crystal panel;

the level shift circuit for the GOA structure liquid crystal panel comprises a sequence controller and a level shift chip; the level shift chip comprises a time delay calculation register module; the sequence controller is communicatively coupled to the level shift chip via a start signal line and an Inter-Integrated Circuit bus;

step 2, performing initialization assignment to the time delay calculation register module inside the level shift chip via the Inter-Integrated Circuit bus by the sequence controller;

step 3, generating a start signal and sending the same to the level shift chip via the start signal line by the sequence controller;

step 4, triggering the level shift chip to output at least four sets of sequence signals on a basis of the start signal according to the initialization assignment of the time delay calculation register module and raising voltages of the start signal and the at least four sets of sequence signals; respectively transmitting the start signal and each set of sequence signal after raising the voltages to the GOA structure liquid crystal panel via one signal line.

The Inter-Integrated Circuit bus comprises a serial data signal line employed for transmitting serial data signals and a serial sequence signal line employed for transmitting serial sequence signals.

In the step 2, the initialization assignment of the time delay calculation register module is determined according to the serial data signals and the serial sequence signals.

In the step 4, the level shift chip is triggered to output the at least four sets of sequence signals on a basis of a rising edge of the start signal according to the initialization assignment of the time delay calculation register module; a generation point of the each set of sequence signal and the rising edge of the start signal are spaced with a corresponding initialization assignment.

In the step 4, continue periods and periodic times of high voltage levels of the at least four sets of sequence signals are determined according to the initialization assignment of the time delay calculation register module.

The benefits of the present invention are: the present invention provides a level shift circuit and a level shift method for a GOA structure liquid crystal panel. The time delay calculation register module is provided inside the level shift chip. The start signal line and the Inter-Integrated Circuit bus are employed to communicatively couple the sequence controller and the level shift chip. the sequence controller performs initialization assignment to the time delay calculation register module inside the level shift chip via the Inter-Integrated Circuit bus, and sends a start signal to the level shift chip via the start signal line; the level shift chip is triggered to output at least four sets of sequence signals on a basis of the start signal according to the initialization assignment of the time delay calculation register module and raises voltages of the start signal and the at least four sets of sequence signals to drive the GOA structure liquid crystal panel. It is capable of decreasing the lead count between the sequence controller and the level shift chip to reduce the package size of the sequence controller and the level shift chip and to decrease the total wiring amount between the sequence controller and the level shift chip for reducing the dimension of the circuit drive board, lowering the production cost and realizing the generation of more sequence signals with lower cost.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a diagram of a level shift circuit for a GOA structure liquid crystal panel according to prior art;

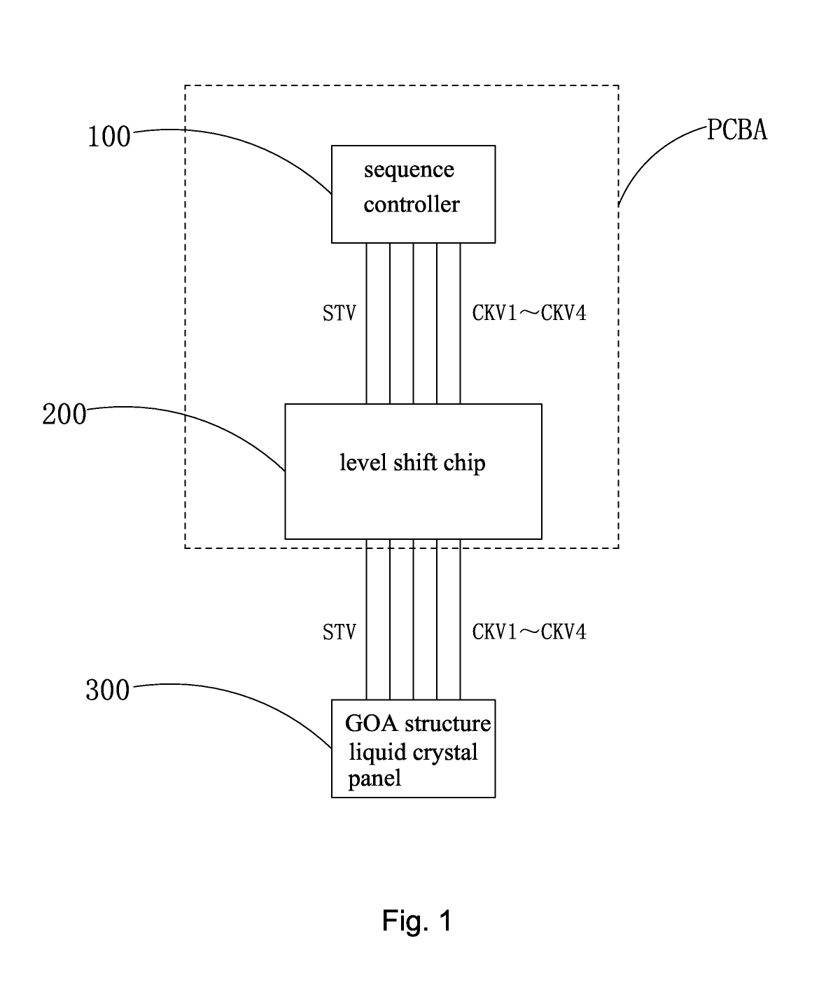

FIG. 2 is a sequence diagram of the circuit shown in FIG. 1 before raising the voltages;

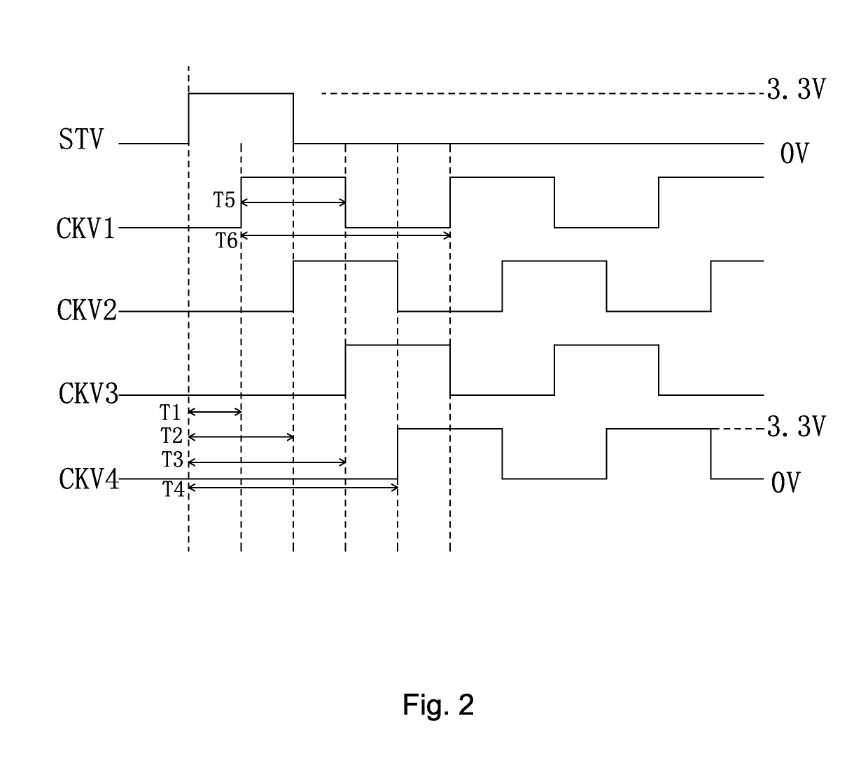

FIG. 3 is a sequence diagram of the circuit shown in FIG. 1 after raising the voltages;

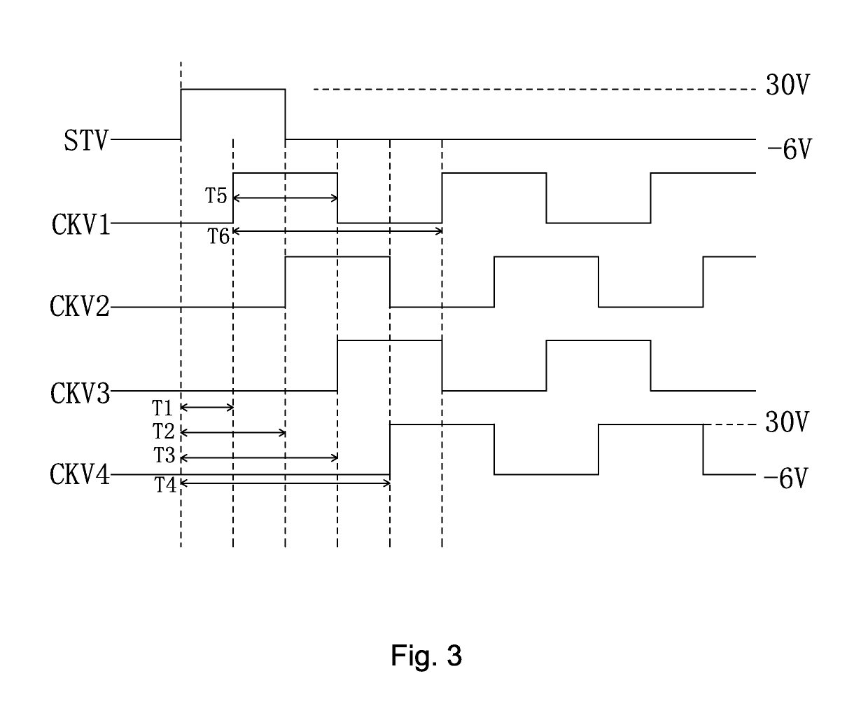

FIG. 4 is a diagram of a level shift circuit for a GOA structure liquid crystal panel according to the present invention;

FIG. 5 is a sequence diagram of the circuit shown in FIG. 4 before raising the voltages;

FIG. 6 is a sequence diagram of the circuit shown in FIG. 4 after raising the voltages.

### DETAILED DESCRIPTION OF PREFERRED EMBODIMENTS

For better explaining the technical solution and the effect of the present invention, the present invention will be further described in detail with the accompanying drawings and the specific embodiments.

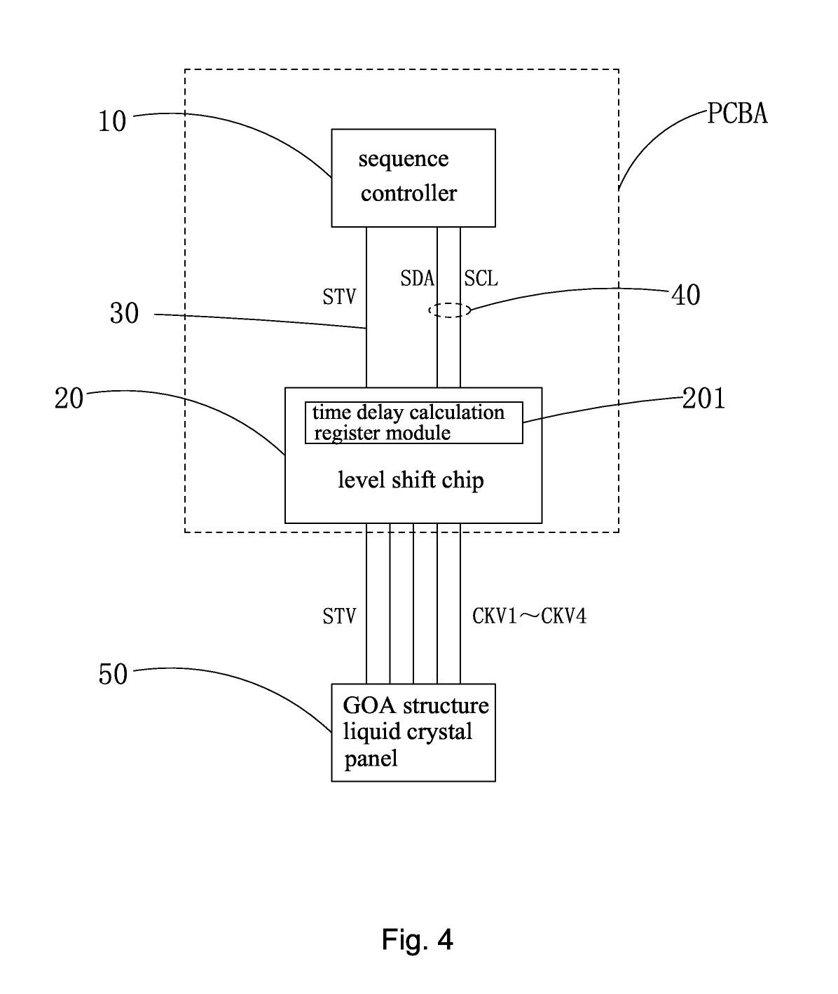

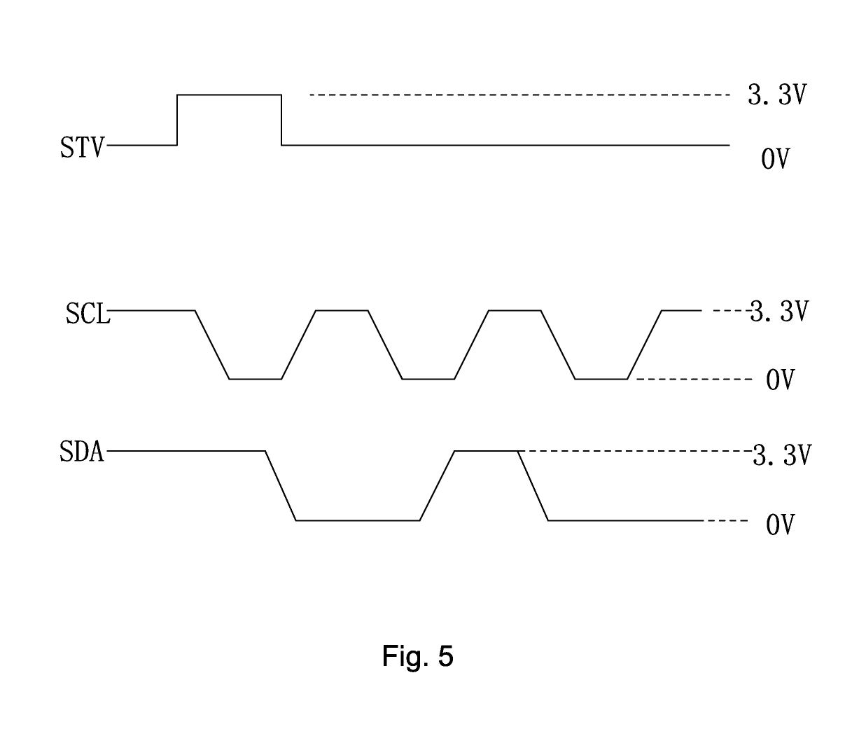

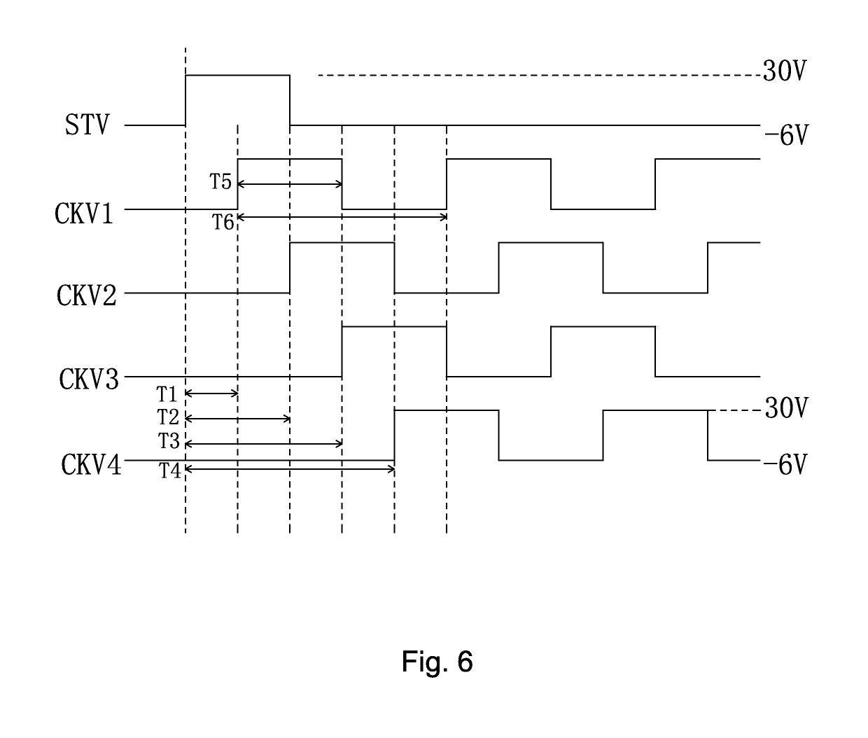

Please refer to FIG. 4, FIG. 5 and FIG. 6, together. The present invention provides a level shift circuit for a GOA structure liquid crystal panel. The level shift circuit for the GOA structure liquid crystal panel comprises: a sequence controller 10 and a level shift chip 20. The sequence controller 10 and the level shift chip 20 are positioned on a circuit drive board PCBA.

The level shift chip 20 comprises a time delay calculation register module 201.

The sequence controller 10 is communicatively coupled to the level shift chip 20 via a start signal line 30 and an Inter-Integrated Circuit bus 40.

The Inter-Integrated Circuit bus 40. comprises a serial data signal line employed for transmitting serial data signals SDA and a serial sequence signal line employed for transmitting serial sequence signals SCL.

The sequence controller is employed to perform initialization assignment T1-Tn to the time delay calculation register module 201 inside the level shift chip 20 via the Inter-Integrated Circuit bus 40, where n is a positive integer, and sends a start signal STV to the level shift chip 20 via the start signal line 30.

The level shift chip 20 is employed to be triggered to output at least four sets of sequence signals CKV1-CKVn on a basis of the start signal STV according to the initialization assignment T1-Tn of the time delay calculation register module 201 and raises voltages of the start signal STV and the at least four sets of sequence signals CKV1-CKVn; the start signal STV and each set of sequence signal after raising the voltages are respectively transmitted to the GOA structure liquid crystal panel 50 via one signal line.

Compared with a level shift circuit for a GOA structure liquid crystal panel according to prior art, the level shift circuit for the GOA structure liquid crystal panel according to the present invention can decrease the lead count between the sequence controller 10 and the level shift chip 20 to reduce the package size of the sequence controller 10 and the level shift chip 20 and to decrease the total wiring amount between the sequence controller 10 and the level shift chip 20 for reducing the dimension of the circuit drive board PCBA and lowering the production cost.

Furthermore, the level shift chip 20 is triggered to output the at least four sets of sequence signals CKV1-CKVn on a basis of a rising edge of the start signal STV according to the initialization assignment T1-Tn of the time delay calculation register module 201.

A generation point of the each set of sequence signal CKVn and the rising edge of the start signal STV are spaced with a corresponding initialization assignment Tn.

Continue periods Tn+1 and periodic times Tn+2 of high voltage levels of the at least four sets of sequence signals CKV1-CKVn are also determined according to the initialization assignment of the time delay calculation register module 201.

Specifically, that the level shift chip 20 outputs four sets of sequence signals CKV1-CKV4 is illustrated with combination of FIG. 4, FIG. 5. The sequence controller 10 sends the serial data signals SDA and the serial sequence signals SCL to the time delay calculation register module 201 inside the level shift chip 20 respectively via the serial data signal line and the serial sequence signal line of the Inter-Integrated Circuit bus 40 for determining the initialization assignment T1-T4 to the time delay calculation register module 201, and sends the start signal STV to the level shift chip 20 via the start signal line 30. All the low voltage levels of the start signal STV, the serial data signals SDA and the serial sequence signals SCL are 0 V, and the high voltage levels are 3.3 V.

In conjunction with FIG. 4, FIG. 6, the level shift chip 20 correctly identifies the rising edge of the start signal STV, and outputs four sets of sequence signals CKV1-CKV4 on a basis of the rising edge of the start signal STV, and raises voltages of the start signal STV and the four sets of sequence signals CKV1-CKV4.A generation point of the first set of sequence signal CKV1 and the rising edge of the start signal STV are spaced with a corresponding period of the initialization assignment T1. A generation point of the second set of sequence signal CKV2 and the rising edge of the start signal STV are spaced with a corresponding period of the initialization assignment T2. A generation point of the third set of sequence signal CKV3 and the rising edge of the start signal STV are spaced with a corresponding period of the initialization assignment T3. A generation point of the fourth set of sequence signal CKV4 and the rising edge of the start signal STV are spaced with a corresponding period of the initialization assignment T4. Besides, the continue periods T5 and the periodic times T6 of high voltage levels of the four sets of sequence signals CKV1-CKV4 are also determined according to the initialization assignment of the time delay calculation register module 201. For the liquid crystal panels of different resolutions, the continue periods T5 and the periodic times T6 of high voltage levels can be set according to different initialization assignments. After the level shift chip 20 raises the voltage levels, all the low voltage levels of the start signal STV, and the first, the second, the third, the fourth sets of sequence signals CKV1, CKV2, CKV3, CKV4 are −6 V, and the high voltage levels are 30 V, which can employed for driving the TFTs in the GOA structure liquid crystal panel 50 and realizing the scan line by line. In this embodiment, only four sets of sequence signals are illustrated for explanation. However, the present invention is not limited thereby and applicable for the condition of more sets of sequence signals. As more sequence signals are required for the GOA structure liquid crystal panel 50, the present invention can decrease the lead count between the sequence controller 10 and the level shift chip 20 to reduce the package size of the sequence controller 10 and the level shift chip 20 and to decrease the total wiring amount between the sequence controller 10 and the level shift chip 20 for reducing the dimension of the circuit drive board PCBA. The result of lowering the production cost can be more effective.

Please refer to FIG. 4, FIG. 5 and FIG. 6, together. The present invention further provides a level shift method for a GOA structure liquid crystal panel, comprising steps of:

step 1, providing the GOA structure liquid crystal panel 50 and a level shift circuit for the GOA structure liquid crystal panel.

The level shift circuit for the GOA structure liquid crystal panel comprises: a sequence controller 10 and a level shift chip 20. The sequence controller 10 and the level shift chip 20 are positioned on a circuit drive board PCBA. The level shift chip 20 comprises a time delay calculation register module 201. The sequence controller 10 is communicatively coupled to the level shift chip 20 via a start signal line 30 and an Inter-Integrated Circuit bus 40.

The Inter-Integrated Circuit bus 40. comprises a serial data signal line employed for transmitting serial data signals SDA and a serial sequence signal line employed for transmitting serial sequence signals SCL.

step 2, performing initialization assignment T1-Tn to the time delay calculation register module 201 inside the level shift chip 20 via the Inter-Integrated Circuit bus 40 by the sequence controller 10. n is a positive integer.

Specifically, in the step 2, the initialization assignment T1-Tn of the time delay calculation register module 201 is determined according to the serial data signals SDA and the serial sequence signals SCL.

step 3, generating a start signal STV and sending the same to the level shift chip 20 via the start signal line 30 by the sequence controller 10.

Specifically, with combination of FIG. 4, FIG. 5, all the low voltage levels of the start signal STV, the serial data signals SDA and the serial sequence signals SCL are 0 V, and the high voltage levels are 3.3 V.

step 4, triggering the level shift chip 20 to output at least four sets of sequence signals CKV1-CKVn on a basis of the start signal STV, of which the basis can be preferably to be the rising edge of the start signal STV according to the initialization assignment T1-Tn of the time delay calculation register module 201 and raising voltages of the start signal STV and the at least four sets of sequence signals CKV1-CKVn; respectively transmitting the start signal STV and each set of sequence signal after raising the voltages to the GOA structure liquid crystal panel 50 via one signal line.

Furthermore, in the step 4, a generation point of the each set of sequence signal CKVn and the rising edge of the start signal STV are spaced with a corresponding initialization assignment Tn. Continue periods Tn+1 and periodic times Tn+2 of high voltage levels of the at least four sets of sequence signals CKV1-CKVn are also determined according to the initialization assignment of the time delay calculation register module 201.

Specifically, that the level shift chip 20 outputs four sets of sequence signals CKV1-CKV4 is illustrated with combination of FIG. 4, FIG. 6. The level shift chip 20 correctly identifies the rising edge of the start signal STV, and outputs four sets of sequence signals CKV1-CKV4 on a basis of the rising edge of the start signal STV, and raises voltages of the start signal STV and the four sets of sequence signals CKV1-CKV4. A generation point of the first set of sequence signal CKV1 and the rising edge of the start signal STV are spaced with a corresponding period of the initialization assignment T1. A generation point of the second set of sequence signal CKV2 and the rising edge of the start signal STV are spaced with a corresponding period of the initialization assignment T2. A generation point of the third set of sequence signal CKV3 and the rising edge of the start signal STV are spaced with a corresponding period of the initialization assignment T3. A generation point of the fourth set of sequence signal CKV4 and the rising edge of the start signal STV are spaced with a corresponding period of the initialization assignment T4. Besides, the continue periods T5 and the periodic times T6 of high voltage levels of the four sets of sequence signals CKV1-CKV4 are also determined according to the initialization assignment of the time delay calculation register module 201. For the liquid crystal panels of different resolutions, the continue periods T5 and the periodic times T6 of high voltage levels can be set according to different initialization assignments. After the level shift chip 20 raises the voltage levels, all the low voltage levels of the start signal STV, and the first, the second, the third, the fourth set of sequence signals CKV1, CKV2, CKV3, CKV4 are −6 V, and the high voltage levels are 30 V, which can employed for driving the TFTs in the GOA structure liquid crystal panel 50 and realizing the scan line by line. In this embodiment, only four sets of sequence signals are illustrated for explanation. However, the present invention is not limited thereby and applicable for the condition of more sets of sequence signals. As more sequence signals are required for the GOA structure liquid crystal panel 50, the present invention can decrease the lead count between the sequence controller 10 and the level shift chip 20 to reduce the package size of the sequence controller 10 and the level shift chip 20 and to decrease the total wiring amount between the sequence controller 10 and the level shift chip 20 for reducing the dimension of the circuit drive board PCBA. The result of lowering the production cost can be more effective.

In conclusion, in the level shift circuit and the level shift method for the GOA structure liquid crystal panel according to the present invention, the time delay calculation register module is provided inside the level shift chip. The start signal line and the Inter-Integrated Circuit bus are employed to communicatively couple the sequence controller and the level shift chip. the sequence controller performs initialization assignment to the time delay calculation register module inside the level shift chip via the Inter-Integrated Circuit bus, and sends a start signal to the level shift chip via the start signal line; the level shift chip is triggered to output at least four sets of sequence signals on a basis of the start signal according to the initialization assignment of the time delay calculation register module and raises voltages of the start signal and the at least four sets of sequence signals to drive the GOA structure liquid crystal panel. It is capable of decreasing the lead count between the sequence controller and the level shift chip to reduce the package size of the sequence controller and the level shift chip and to decrease the total wiring amount between the sequence controller and the level shift chip for reducing the dimension of the circuit drive board PCBA, lowering the production cost and realizing the generation of more sequence signals with lower cost.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A level shift circuit for a GOA structure liquid crystal panel, comprising a sequence controller and a level shift chip;
the level shift chip comprises a time delay calculation register module;
the sequence controller is communicatively coupled to the level shift chip via a start signal line and an Inter-Integrated Circuit bus;
the sequence controller performs initialization assignment to the time delay calculation register module inside the level shift chip via the Inter-Integrated Circuit bus, and sends a start signal to the level shift chip via the start signal line;
the level shift chip is triggered to output at least four sets of sequence signals on a basis of the start signal according to the initialization assignment of the time delay calculation register module and raises voltages of the start signal and the at least four sets of sequence signals; the start signal and each set of sequence signal after raising the voltages are respectively transmitted to the GOA structure liquid crystal panel via one signal line.

2. The level shift circuit for the GOA structure liquid crystal panel according to claim 1, wherein the Inter-Integrated Circuit bus comprises a serial data signal line employed for transmitting serial data signals and a serial sequence signal line employed for transmitting serial sequence signals.

3. The level shift circuit for the GOA structure liquid crystal panel according to claim 1, wherein the level shift chip is triggered to output at least four sets of sequence signals on a basis of a rising edge of the start signal according to the initialization assignment of the time delay calculation register module.

4. The level shift circuit for the GOA structure liquid crystal panel according to claim 3, wherein a generation point of the each set of sequence signal and the rising edge of the start signal are spaced with a corresponding initialization assignment.

5. The level shift circuit for the GOA structure liquid crystal panel according to claim 4, wherein continue periods and periodic times of high voltage levels of the at least four sets of sequence signals are determined according to the initialization assignment of the time delay calculation register module.

6. A level shift circuit for a GOA structure liquid crystal panel, comprising a sequence controller and a level shift chip;
the level shift chip comprises a time delay calculation register module;
the sequence controller is communicatively coupled to the level shift chip via a start signal line and an Inter-Integrated Circuit bus;
the sequence controller performs initialization assignment to the time delay calculation register module inside the level shift chip via the Inter-Integrated Circuit bus, and sends a start signal to the level shift chip via the start signal line;
the level shift chip is triggered to output at least four sets of sequence signals on a basis of the start signal according to the initialization assignment of the time delay calculation register module and raises voltages of the start signal and the at least four sets of sequence signals; the start signal and each set of sequence signal after raising the voltages are respectively transmitted to the GOA structure liquid crystal panel via one signal line;
wherein the Inter-Integrated Circuit bus comprises a serial data signal line employed for transmitting serial data signals and a serial sequence signal line employed for transmitting serial sequence signals;
wherein the level shift chip is triggered to output the at least four sets of sequence signals on a basis of a rising edge of the start signal according to the initialization assignment of the time delay calculation register module.

7. The level shift circuit for the GOA structure liquid crystal panel according to claim 6, wherein a generation point of the each set of sequence signal and the rising edge of the start signal are spaced with a corresponding initialization assignment.

8. The level shift circuit for the GOA structure liquid crystal panel according to claim 7, wherein continue periods and periodic times of high voltage levels of the at least four sets of sequence signals are determined according to the initialization assignment of the time delay calculation register module.

9. A level shift method for a GOA structure liquid crystal panel, comprising steps of:
step 1, providing the GOA structure liquid crystal panel and a level shift circuit for the GOA structure liquid crystal panel;
the level shift circuit for the GOA structure liquid crystal panel comprises a sequence controller and a level shift chip; the level shift chip comprises a time delay calculation register module; the sequence controller is communicatively coupled to the level shift chip via a start signal line and an Inter-Integrated Circuit bus;
step 2, performing initialization assignment to the time delay calculation register module inside the level shift chip via the Inter-Integrated Circuit bus by the sequence controller;
step 3, generating a start signal and sending the same to the level shift chip via the start signal line by the sequence controller;
step 4, triggering the level shift chip to output at least four sets of sequence signals on a basis of the start signal according to the initialization assignment of the time delay calculation register module and raising voltages of the start signal and the at least four sets of sequence signals; respectively transmitting the start signal and each set of sequence signal after raising the voltages to the GOA structure liquid crystal panel via one signal line.

10. The level shift method for the GOA structure liquid crystal panel according to claim 9, wherein the Inter-Integrated Circuit bus comprises a serial data signal line employed for transmitting serial data signals and a serial sequence signal line employed for transmitting serial sequence signals.

11. The level shift method for the GOA structure liquid crystal panel according to claim 10, wherein in the step 2, determining the initialization assignment of the time delay calculation register module according to the serial data signals and the serial sequence signals.

12. The level shift method for the GOA structure liquid crystal panel according to claim 9, wherein in the step 4, the level shift chip is triggered to output the at least four sets of sequence signals on a basis of a rising edge of the start signal according to the initialization assignment of the time delay calculation register module; a generation point of the each set of sequence signal and the rising edge of the start signal are spaced with a corresponding initialization assignment.

13. The level shift method for the GOA structure liquid crystal panel according to claim 12, wherein in the step 4, continue periods and periodic times of high voltage levels of the at least four sets of sequence signals are determined according to the initialization assignment of the time delay calculation register module.
